(19) United States
(12) Patent Application Publication
(10) Pub. No.: US 2024/0068992 A1
(43) Pub. Date: Feb. 29, 2024

(54) ULTRASONIC INSPECTION DEVICE

(71) Applicant: YAMAHA FINE TECHNOLOGIES CO., LTD., Hamamatsu-shi (JP)

(72) Inventors: Akihiro NARA, Hamamatsu-shi (JP); Takao KOYAMA, Hamamatsu-shi (JP)

(21) Appl. No.: 18/503,264

(22) Filed: Nov. 7, 2023

Related U.S. Application Data
(63) Continuation of application No. PCT/JP2021/029156, filed on Aug. 5, 2021.

(30) Foreign Application Priority Data
May 11, 2021 (JP) 2021-080200

(51) Int. Cl. G01N 29/22; G01N 29/44

(52) U.S. Cl. CPC G01N 29/221; G01N 29/4436; G01N 2291/103

(57) ABSTRACT

An ultrasonic inspection device includes a transmitter configured to transmit an ultrasonic beam to a subject. The ultrasonic inspection device further includes a plurality of receivers that each have a reception surface configured to receive the ultrasonic beam having transmitted through the subject. An area of the reception surface of each of the plurality of receivers is equal to or less than (10×λ)², where λ is a wavelength of the ultrasonic beam.

### CROSS-REFERENCE TO RELATED APPLICATIONS

The present application is a continuation application of International Application No. PCT/JP2021/029156, filed Aug. 5, 2021, which claims priority to JP Patent Application No. 2021-080200, filed May 11, 2021. The contents of these applications are incorporated herein by reference.

### BACKGROUND

### Technical Field

The present disclosure relates to an ultrasonic inspection device.

### Background Art

Conventionally, there is an ultrasonic inspection device that has a transmission unit that transmits ultrasonic waves to a subject and a reception unit that receives ultrasonic waves having transmitted through the subject, and that detects defects inside the subject by analyzing the reception state of the ultrasonic waves with respect to the reception unit. Japanese Unexamined Patent Application, First Publication No. JP 2020-176916 discloses an ultrasonic inspection device (ultrasonic flaw detector) which can detect defects inside an inspection target body highly precisely by making the reception surface of the reception unit smaller than the transmission surface of the transmission unit.

### SUMMARY

However, with conventional ultrasonic inspection devices, there is a problem in that it takes time to inspect defects in a subject highly precisely (high resolution) over a wide range.

The present disclosure has been made in view of the circumstances described above. An object of the present disclosure is to provide an ultrasonic inspection device capable of inspecting defects in a subject highly precisely and in a short time, even if the subject to be inspected has a large area.

According to a first aspect of the present disclosure, an ultrasonic inspection device includes a transmitter configured to transmit an ultrasonic beam to a subject. The ultrasonic inspection device further includes a plurality of receivers that each have a reception surface configured to receive the ultrasonic beam having transmitted through the subject. An area of the reception surface of each of the plurality of receivers is equal to or less than (10×λ)², where λ is a wavelength of the ultrasonic beam.

### BRIEF DESCRIPTION OF THE DRAWINGS

FIG. 1 is a cross-sectional view schematically showing a main part of an ultrasonic inspection device according to one embodiment.

FIG. 2 is a cross-sectional view taken along the line II-II in FIG. 1.

FIG. 3 is a cross-sectional view showing a first example of a reception unit of an ultrasonic inspection device according to one embodiment.

FIG. 4 is a cross-sectional view showing a second example of a reception unit of an ultrasonic inspection device according to one embodiment.

FIG. 5 is a plan view showing a first example of a reception surface of a receiver of an ultrasonic inspection device according to one embodiment.

FIG. 6 is a plan view showing a second example of a reception surface of a receiver of an ultrasonic inspection device according to one embodiment.

FIG. 7 is a plan view showing a third example of a reception surface of a receiver of an ultrasonic inspection device according to one embodiment.

FIG. 8 is a cross-sectional view showing the positional relationship between an end portion of a subject, and a transmission unit and receiver in an ultrasonic inspection device according to one embodiment.

FIG. 9 is a functional block diagram of an ultrasonic inspection device according to one embodiment.

FIG. 10 is a diagram showing how an ultrasonic wave transmitted from the transmission unit of the ultrasonic inspection device according to one embodiment is diffracted at the periphery of the defect of the subject.

FIG. 11 is a perspective view schematically showing a main part of an ultrasonic inspection device according to another embodiment.

### DETAILED DESCRIPTION OF THE EMBODIMENTS

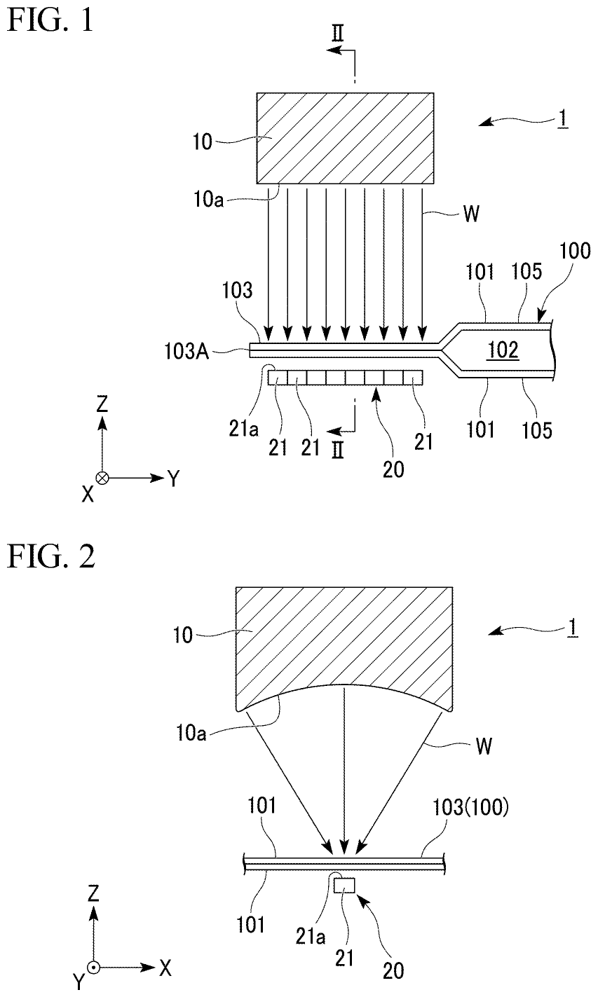

Hereinafter, embodiments of the present disclosure are described with reference to FIG. 1 to FIG. 10.

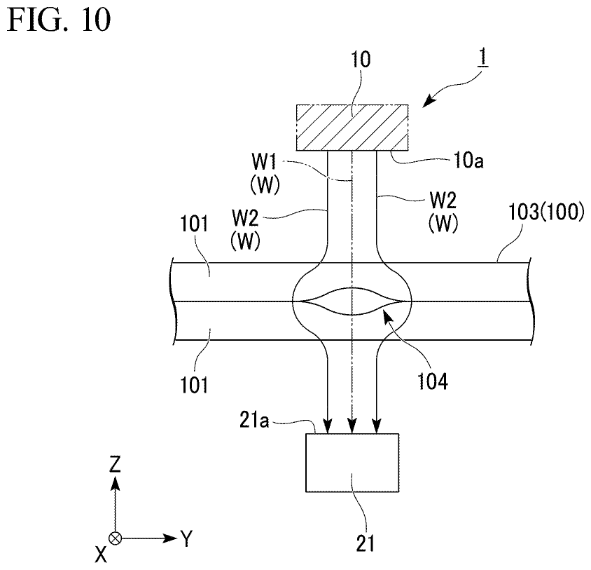

As shown in FIG. 1 and FIG. 2, an ultrasonic inspection device 1 of the present embodiment uses ultrasonic waves to inspect defects in a subject 100. The subject 100 in the present embodiment is a packaging container in which an accommodation space 102 is formed inside by overlapping and joining edges of container members 101. Although the container members 101 in the illustrated example are sheet members, the container members 101 may be arbitrary members such as cup-shaped members. A part to be inspected for defects in the subject 100, which is a packaging container, is a joint portion 103 where the container members 101 are overlapped and joined. In the following description, this joint portion 103 may also be referred to as a subject 100. As illustrated in FIG. 10, a defect 104 in the subject 100 of this embodiment, is a peeled portion of the container member 101 at the joint portion 103.

In the drawing, the direction in which the container members 101 overlap at the joint portion 103 is indicated by the Z-axis direction. Also, the direction away from the non-joint portion 105 of the container member 101, that forms the accommodation space 102 and is not joined, is defined as the width direction of the joint portion 103 and is indicated by the Y-axis direction. Also, the longitudinal direction of the joint portion 103 orthogonal to the Z-axis direction and the Y-axis direction is indicated by the X-axis direction.

As shown in FIG. 1 and FIG. 2, the ultrasonic inspection device 1 includes a transmission unit 10 and a reception unit 20.

The transmitter 10 has a transmission surface 10a that transmits an ultrasonic beam W toward the subject 100. In this embodiment, the transmitter 10 transmits the ultrasonic beam W toward the joint portion 103 of the packaging container, which is the subject 100. The ultrasonic beam W transmitted from the transmitter 10 passes through the joint portion 103 substantially in the direction in which the container members 101 overlap. The direction in which the ultrasonic beam W passes through the joint portion 103 is not strictly limited to the direction in which the container members 101 overlap (the Z-axis direction), but may be a direction that is inclined with respect to the direction in which the container members 101 overlap.

In this embodiment, the transmission surface 10a of the transmitter 10 is formed in an arcuate shape recessed to the Z-axis positive direction side when viewed from the Y-axis direction, as shown in FIG. 2. Further, the transmission surface 10a extends linearly in the Y-axis direction as shown in FIG. 1. Because of this, the shape of the transmission surface 10a viewed from the Y-axis direction does not change regardless of the position in the Y-axis direction. That is, the shape of the transmission surface 10a of this embodiment is similar to a portion of the inner peripheral surface of a cylinder in the circumferential direction.

With the transmission surface 10a formed as described above, the ultrasonic beam W transmitted from the transmission surface 10a of the transmitter 10, converges (focuses) in the X-axis direction as it goes in the Z-axis negative direction as shown in FIG. 1 and FIG. 2, but does not converge in the Y-axis direction. As a result, the ultrasonic beam W becomes linear with a short length in the X-axis direction and a long length in the Y-axis direction at the converged position.

The reception unit 20 has a plurality of receivers 21. Each receiver 21 has a reception surface 21a that receives the ultrasonic beam W having transmitted through the subject 100. The area of the reception surface 21a is limited, and is expressed using the wavelength of the ultrasonic beam W. The area of the reception surface 21a is, for example, not more than (10×λ)², where X is the wavelength of the ultrasonic beam W.

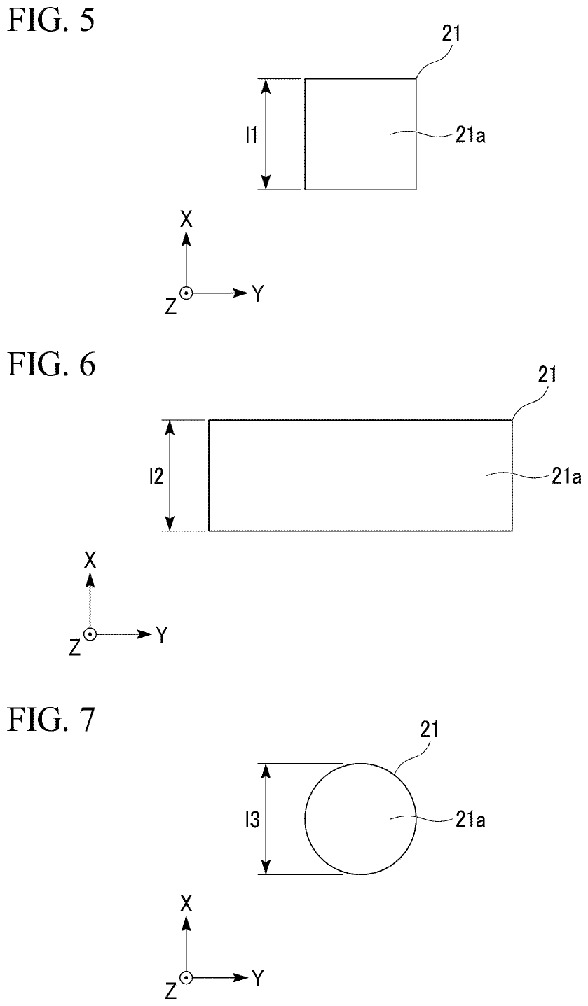

The reception surface 21a of the receiver 21 may be formed in a square shape, for example, as shown in FIG. 5. When the area of the reception surface 21a is not more than (10×λ)², the length 11 of one side of the reception surface 21a is preferably not more than (10×λ). Note that the length of the diagonal line of the square reception surface 21a may be not more than (10×λ).

The reception surface 21a of the receiver 21 may be formed in a rectangular shape, for example, as shown in FIG. 6. When the area of the reception surface 21a is not more than (10×λ)², the length 12 of the short side of the reception surface 21a is preferably not more than (10×λ). It should be noted that the length of the long side or diagonal of the rectangular reception surface 21a may be not more than (10×λ).

The reception surface 21a of the receiver 21 may be formed in a circular shape as shown for example in FIG. 7. When the area of the reception surface 21a is not more than (10×λ)², the length 13 of the diameter of the reception surface 21a is preferably not more than (10×λ).

The area of the reception surface 21a may be, for example, not more than (6×λ)².

In this case, the length 11 of one side of the square reception surface 21a, the length 12 of the short side of the rectangular reception surface 21a, the length 13 of the diameter of the circular reception surface 21a, and the like, are preferably not more than (6×λ).

Also, the area of the reception surface 21a may be, for example, not more than (4×λ)². In this case, the length 11 of one side of the square reception surface 21a, the length 12 of the short side of the rectangular reception surface 21a, the length 13 of the diameter of the circular reception surface 21a, and the like, are preferably not more than (4×λ).

Furthermore, the area of the reception surface 21a may be, for example, not more than (2×λ)². In this case, the length 11 of one side of the square reception surface 21a, the length 12 of the short side of the rectangular reception surface 21a, the length 13 of the diameter of the circular reception surface 21a, and the like, are preferably not more than (2×λ).

As shown in FIG. 1 and FIG. 2, the plurality of receivers 21 are arranged in an array corresponding to the converged linear ultrasonic beam W. That is, the plurality of receivers 21 are arranged in a row in the Y-axis direction. The plurality of receivers 21 are not necessarily arranged strictly at the position where the ultrasonic beam W converges, but may be arranged for example at a position shifted away from the transmitter 10 (in the Z-axis negative direction) from the position where the ultrasonic beam W converges. However, it is more preferable that the plurality of receivers 21 are arranged as close as possible to the position where the ultrasonic beam W converges.

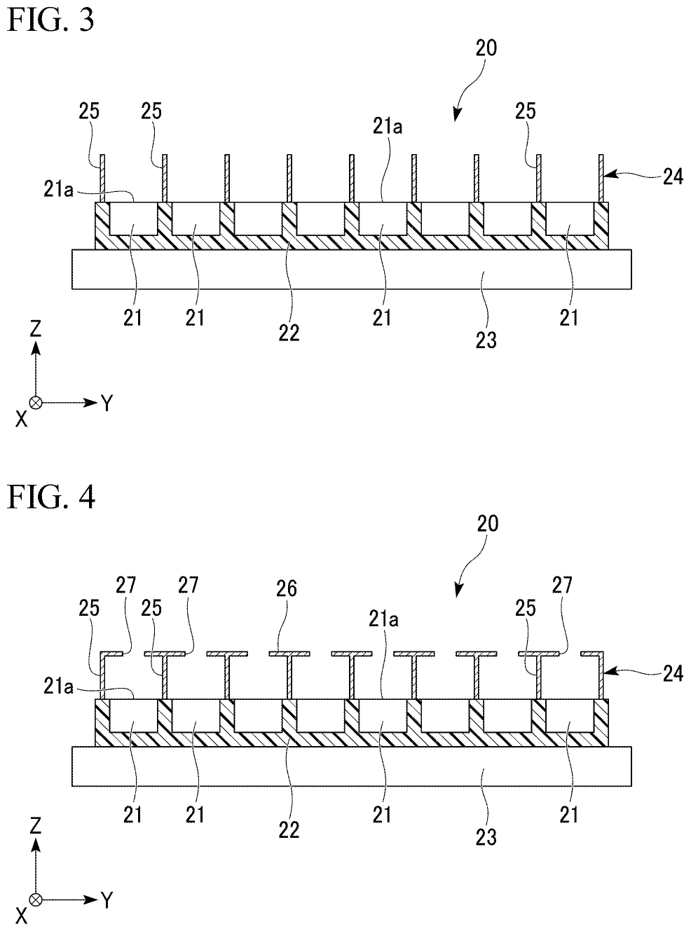

In this embodiment, the plurality of receivers 21 are arranged spaced apart from each other, as shown in FIG. 3 and FIG. 4. A layer or member having acoustic characteristics different from those of the receivers 21 may be interposed between the adjacent receivers 21. Here acoustic characteristics include acoustic impedance. In the reception unit 20 illustrated in FIG. 3 and FIG. 4, resin 22 is interposed between adjacent receivers 21. Note that, for example, an air layer, paper, or the like may be interposed between the adjacent receivers 21.

In this embodiment, the resin 22 integrally fixes the plurality of receivers 21.

The reception unit 20 of this embodiment further includes an FET substrate 23. The FET substrate 23 outputs a received signal corresponding to the ultrasonic beam W received by the receivers 21, to the outside. The plurality of receivers 21 are integrally provided on the FET substrate 23. In FIG. 3 and FIG. 4, the resin 22 is interposed between the receivers 21 and the FET substrate 23. However the receivers 21 and the FET substrate 23 may be in direct contact with each other for example.

The reception unit 20 of this embodiment further includes a partition wall portion 24. The partition wall portion 24 extends in a direction away from the reception surfaces 21a of the receivers 21 (Z-axis positive direction), and partitions the space above the plurality of reception surfaces 21a for each reception surface 21a. The partition wall portion 24 forms a plurality of cylindrical bodies 25 extending in the Z-axis positive direction from the periphery of each reception surface 21a.

For example, as shown in FIG. 4, the reception unit 20 may further include a lid portion 26 that covers the openings at the end of the partition wall portion 24 (cylindrical bodies 25) in the extending direction. Communication holes 27 that connect the inside and the outside of each cylindrical body 25 are formed in the lid portion 26. The size of the communication holes 27 is smaller than the space inside the cylindrical bodies 25 when viewed from the Z-axis direction.

As shown in FIG. 1 and FIG. 2, the subject 100 is placed between the transmitter 10 and the reception unit 20 (especially the receivers 21). Specifically, the joint portion 103 of the packaging container, which is the subject 100, is arranged at a position where the ultrasonic beam W transmitted from the transmitter 10 converges. Moreover the joint portion 103 of the packaging container is arranged so that its width direction (Y-axis direction) faces the longitudinal direction of the converged linear ultrasonic beam W. As a result, the ultrasonic beam W transmitted from the transmitter 10 is received by the receivers 21 after having transmitted through the joint portion 103 which is the subject 100.

In the following description, the tip in the extension direction (Y-axis negative direction) of the joint portion 103 with respect to the non-joint portion 105, is called an end portion 103A of the joint portion 103 (the subject 100).

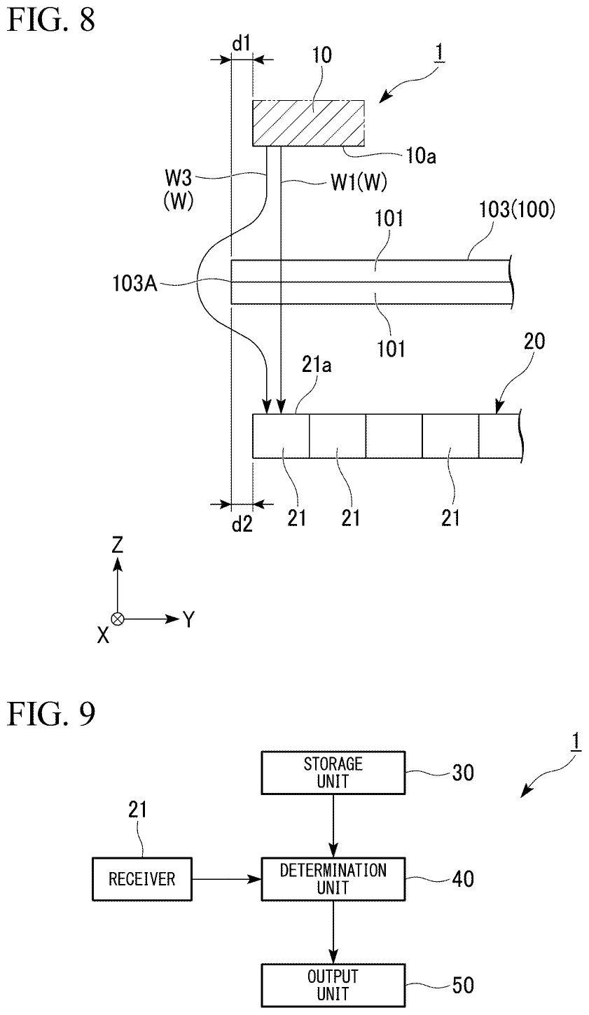

As shown in FIG. 8, in the present embodiment, the transmitter 10 and the receivers 21 are positioned on the inside (Y-axis positive direction side) with respect to the end portion 103A of the joint portion 103 (subject 100) in the orthogonal direction (Y-axis direction) perpendicular to the transmission direction (mainly the Z-axis negative direction) of the ultrasonic beam W. That is, the transmitter 10 and the receivers 21 are positioned so as not to protrude further to the Y-axis negative direction side from the end portion 103A of the joint portion 103. At least one of the distance d1 between the end portion 103A of the joint portion 103 and the transmitter 10 in the Y-axis direction, and the distance d2 between the end portion 103A of the joint portion 103 and the receiver 21, is not less than the wavelength of the ultrasonic beam W.

In the configuration described above, the transmitter 10 and the receiver 21 may be arranged, for example, so as to protrude to the outside (Y-axis negative direction side) from the end portion 103A of the joint portion 103 (subject 100). In this case, the ultrasonic beam W transmitted or received by the part of the transmitter 10 or the receiver 21 protruding from the end portion 103A, may be ignored in the signal processing. As a result, the state in which the transmitter 10 and the receiver 21 protrude outward from the end portion 103A of the joint portion 103 can be regarded as substantially equivalent to the state in which the transmitter 10 and the receiver 21 are located further inside (the Y axis positive direction side) than the end portion 103A of the joint portion 103.

Also, in the configuration described above, the direction in which the joint portion 103 extends with respect to the non-joint portion 105, does not have to be strictly perpendicular to the transmission direction of the ultrasonic beam W. Because of this, the transmitter 10 and the receivers 21 may be positioned inside with respect to the end portion 103A of the joint portion 103 (the subject 100) in a crossing direction that intersects the transmission direction of the ultrasonic beam W (mainly the Z-axis negative direction), for example.

As shown in FIG. 9, the ultrasonic inspection device 1 of this embodiment further includes a storage unit (memory) 30 and a determination unit (memory and processor) 40. Moreover, the ultrasonic inspection device 1 of this embodiment also includes an output unit 50.

The storage unit 30 stores, as a reference waveform, the waveform of the ultrasonic beam W when it is received by the receivers 21 after having transmitted through a reference subject in which the subject 100 has no defect 104 (see FIG. 10). The reference waveform may be the waveform of the ultrasonic beam W actually received by the receiver 21, or may be a waveform simulating the waveform of the ultrasonic beam W received by the receiver 21.

The determination unit 40 determines the presence or absence of the defect 104 in the inspection subject 100, based on the phase of the waveform to be inspected, which is the waveform of the ultrasonic beam W received by the receiver 21 having transmitted through the inspection subject (that is, the subject 100) which is to be inspected for the presence or absence of the defect 104, and the phase of the reference waveform stored in the storage unit 30.

The output unit 50 outputs the result determined by the determination unit 40, to a display device or the like.

An example of the method by which the determination unit 40 determines whether or not there is a defect 104, will be described below.

First, the determination unit 40 calculates a correlation value between the phase of the reference waveform stored in the storage unit 30, and the phase of the waveform to be inspected. The correlation value is a value obtained by integrating a product of the reference waveform and the waveform to be inspected. After that, the determination unit 40 determines the presence or absence of the defect 104 in the inspection subject 100, based on the correlation value. Specifically, when the correlation value is high, the determination unit 40 determines that the inspection subject 100 does not have the defect 104, and when the correlation value is low, the determination unit 40 determines that the inspection subject 100 has the defect 104.

As described above, in the ultrasonic inspection device 1 of the present embodiment, the area of the reception surface 21a of each receiver 21 that receives the ultrasonic beam W transmitted from the transmitter 10, is set to not more than (10×λ)², and the area of the reception surface 21a is sufficiently small. Thereby, the defect 104 in the subject 100 can be detected highly precisely.

Also, by arranging a plurality of receivers 21 having small reception surfaces 21a in an array, the total area of the reception surfaces 21a can be increased. As a result, even if the area of the subject 100 to be inspected is large, a defect 104 in the subject 100 can be inspected highly precisely and in a short time.

In addition, in the ultrasonic inspection device 1 of the present embodiment, by setting the length 11 of one side of the square reception surface 21a, or the length 13 of the diameter of the circular reception surface 21a to not more than (2×λ), the area of the reception surface 21a can be set to not more than (2×λ)².

In addition, by making the length 12 of the short side of the rectangular reception surface 21a smaller than (10×λ), while the area of the reception surface 21a is set to be not more than (10×λ)², the length of the long side of the rectangular reception surface 21a can be allowed to exceed (10×λ).

Also, in the ultrasonic inspection device 1 of the present embodiment, the plurality of receivers 21 are arranged spaced apart from each other. Because of this, it is possible to prevent the sound pressure of the ultrasonic beam W received by a predetermined receiver 21 from being transmitted to another adjacent receiver 21. That is, it is possible to acoustically insulate between the adjacent receivers 21. Therefore, physical crosstalk between the adjacent receivers 21 can be reduced.

Further, in the ultrasonic inspection device 1 of the present embodiment, the resin 22 having acoustic characteristics different from those of the receivers 21 is interposed between the adjacent receivers 21. Because of this, even if the interval between adjacent receivers 21 is reduced, physical crosstalk between adjacent receivers 21 can be more effectively reduced. Therefore, it is possible to inspect the defect 104 in the subject 100 with more precision. Moreover, when the resin 22 is interposed between the receivers 21, the resin 22 can also be used to integrally fix the plurality of receivers 21.

Even if an air layer is interposed between the adjacent receivers 21, the same effect as described above can be obtained because the air layer and the receivers 21 have different acoustic characteristics.

In addition, in the ultrasonic inspection device 1 of the present embodiment, the determination unit 40 calculates a correlation value between a phase of the reference waveform stored in the storage unit 30, and a phase of the waveform to be inspected, and determines the presence or absence of a defect 104 in the inspection subject 100 based on the correlation value. Because of this, even if the size of the defect 104 in the inspection subject 100 is equal to or smaller than the size of the receiver 21 (reception surface 21a), the defect 104 can be detected. This point will be described below.

The determination unit 40 can determine whether or not the phase of the waveform to be inspected matches the phase of the reference waveform, by calculating the correlation value. Then, when the phase of the waveform to be inspected matches the phase of the reference waveform, the determination unit 40 can determine that there is no defect 104 in the inspection subject 100. On the other hand, when the phase of the reference waveform and the phase of the waveform to be inspected are out of phase, then as shown in FIG. 10, the ultrasonic beam W2 is diffracted at the periphery of the small-sized defect 104 and then reaches the reception surface 21a of the receiver 21. Because of this, the phase of the ultrasonic beam W2 diffracted at the defect 104 is shifted with respect to the phase of the ultrasonic beam W1 that is not diffracted. Accordingly, the determination unit 40 can determine that the inspection subject 100 has the defect 104.

As described above, the ultrasonic inspection device 1 of the present embodiment can detect defects 104 that are equal to or smaller than the size of the receiver 21. That is, the performance for detecting the defect 104 can be improved.

In addition, in the ultrasonic inspection device 1 of the present embodiment, at least one of the transmitter 10 and the receiver 21 is located inside the end portion 103A of the subject 100 by at least the length of the wavelength of the ultrasonic beam W, in the crossing direction (for example, the Y-axis direction) that intersects the transmission direction (Z-axis direction) of the ultrasonic beam W. Because of this, as shown in FIG. 8, the ultrasonic beam W3 from the transmitter 10 that reaches the receiver 21 without passing through the subject 100, becomes a diffracted wave that wraps around the end portion 103A of the subject 100. The path of this diffracted wave is longer than the path of the ultrasonic beam W1 (transmitted wave) from the transmitter 10 that passes through the subject 100 and reaches the receiver 21. Therefore, the time from when the ultrasonic beams W1 and W3 are transmitted at a predetermined time until the diffracted wave (ultrasonic beam W3) reaches the receiver 21 is longer than the time until the transmitted wave (ultrasonic beam W1) reaches the receiver 21. For this reason, a time window is provided at a time earlier than the time at which the receiver 21 receives the diffracted wave (ultrasonic beam W3) of the ultrasonic beam W that wraps around the end portion 103A of the subject 100, and the presence or absence of the defect 104 in the subject 100 can be inspected based only on the transmitted wave (ultrasonic beam W1) received by the receiver 21 having transmitted through the subject 100 in the time window.

In addition, in the ultrasonic inspection device 1 of the present embodiment, since the plurality of receivers 21 are integrally provided on the FET substrate 23, it is possible to suppress deterioration in the sensitivity of the ultrasonic inspection device 1.

To explain this point, when the size of the reception surface 21a of the receiver 21 becomes smaller, the intensity (amplitude) of the ultrasonic beam W received by the receiver 21 becomes smaller. Therefore, if the receiver 21 and the FET substrate 23 are formed separately and connected to each other by electrical wiring, the sensitivity will be lowered due to electrical loss. On the other hand, by integrally providing the receiver 21 with the FET substrate 23, the above electric wiring can be eliminated or shortened. Thereby, it is possible to suppress a decrease in sensitivity due to electrical loss.

In addition, the ultrasonic inspection device 1 of this embodiment includes the partition wall portion 24 that partitions the spaces above the plurality of reception surfaces 21a for each of the reception surfaces 21a. The partition wall portion 24 forms cylindrical bodies 25 extending in a direction away from each reception surface 21a. This can further reduce physical crosstalk between the adjacent receivers 21 (reception surfaces 21a). Further, by utilizing the cylindrical bodies 25 formed by the partition wall portion 24 as resonance tubes, the sensitivity of the ultrasonic beam W received by the receivers 21 (reception surfaces 21a) can be improved.

Moreover, the ultrasonic inspection device 1 of the present embodiment may include a lid portion 26 that covers the opening at the tip of the partition wall portion 24 (cylindrical bodies 25) in the extending direction (Z-axis positive direction) as illustrated in FIG. 4. Communication holes 27 that connect the inside and the outside of the cylindrical bodies 25 are formed in the lid portion 26. The size of the communication holes 27 seen from the Z-axis direction, is smaller than the size of the inside of the cylindrical bodies 25. When the lid portion 26 is provided at the tip of the partition wall portion 24, the cylindrical bodies 25 and the lid portion 26 can be configured as a Helmholtz resonator. That is, by changing the area of the communication holes 27, it is possible to adjust the resonance frequency in the cylindrical bodies 25, and appropriately adjust the sensitivity of the ultrasonic waves received by the receivers 21 (reception surfaces 21a).

Although the present disclosure has been described in detail above, the present disclosure is not limited to the above embodiments, and various modifications can be made without departing from the scope of the present disclosure.

In the present disclosure, the determination unit 40 may determine the presence or absence of the defect 104 by a method different from the above embodiment. For example, when the phase of the waveform to be inspected does not include a phase different from the phase of the reference waveform (the waveform when there is no defect 104) stored in the storage unit 30 (that is, when the phase of the waveform to be inspected is not different from the phase of the reference waveform stored in the storage unit 30), the determination unit 40 may determine that the inspection subject 100 does not have the defect 104, and when the phase of the waveform to be inspected includes a phase different from the phase of the reference waveform (that is, when the phase of the waveform to be inspected is different from the phase of the reference waveform), the determination unit 40 may determine that the inspection subject 100 has the defect 104.

When the determination unit 40 determines the presence or absence of the defect 104 as described above, even if the size of the defect 104 in the inspection subject 100 is equal to or smaller than the size of the receiver 21 (reception surface 21a), the defect 104 can be detected. This point will be described below.

The fact that the phase of the waveform to be inspected includes a different phase (specific phase) from the phase of the reference waveform, means that the ultrasonic beam W2 reaches the receiver 21 after being diffracted at the periphery of the small-sized defect 104, as illustrated in FIG. 10. This is because the ultrasonic beam W2 reaches the receiver 21 after being diffracted at the periphery of the small-sized defect 104, so that the phase of the diffracted ultrasonic beam W2 shifts with respect to the phase of the non-diffracted ultrasonic beam W1. Therefore, when the phase of the waveform to be inspected includes a phase (specific phase) different from the phase of the reference waveform, the determination unit 40 can determine that the inspection subject 100 has the defect 104.

In the present disclosure, the storage unit 30 may store for example, the defective subject 100 as a reference subject, and store the waveform of the ultrasonic beam W received by the receiver 21 having transmitted through the defective portion of the reference subject, as the reference waveform. In this case, when the determination unit 40 determines the presence or absence of a defect by calculating the correlation value between the phase of the reference waveform and the phase of the waveform to be inspected, the determination unit 40 determines that the inspection subject 100 has the defect 104 when the correlation value is high. Further, regarding the determination unit 40, when the correlation value is low, the determination unit 40 determines that the inspection subject 100 does not have the defect 104.

Moreover, in the case where the reference waveform is a waveform that has passed through a defect portion, then when the determination unit 40 determines the presence or absence of a defect based on whether the phase of the waveform to be inspected includes a phase different from the phase of the reference waveform, the determination unit 40 determines that the inspection subject 100 has the defect 104 when the phase of the waveform to be inspected does not include a phase different from the phase of the reference waveform. Further, in the case where the phase of the waveform to be inspected includes a phase different from the phase of the reference waveform, the determination unit 40 determines that there is no defect 104 in the inspection subject 100.

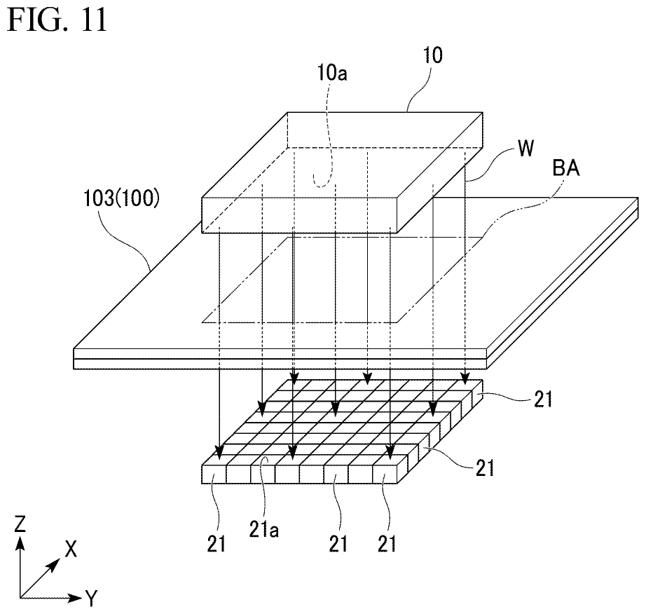

In the present disclosure, the transmission surface 10a of the transmitter 10 may be a flat surface as shown in FIG. 11, for example. In this case, the ultrasonic beam W transmitted from the transmission surface 10a of the transmitter 10 propagates toward the subject 100 without convergence. Because of this, the shape of the ultrasonic beam W orthogonal to the transmission direction (Z-axis negative direction) of the ultrasonic beam W is a planar shape corresponding to the shape of the transmission surface 10a regardless of the position in the Z-axis direction. Since the shape of the transmission surface 10a illustrated in FIG. 11 is rectangular (or square), the shape of the ultrasonic beam W orthogonal to the transmission direction of the ultrasonic beam W is also rectangular (or square). In FIG. 11, the shape (area) of the ultrasonic beam W orthogonal to the transmission direction of the ultrasonic beam W is indicated by reference symbol BA.

In this case, the plurality of receivers 21 are arranged in a matrix corresponding to the planar ultrasonic beam W described above. That is, the plurality of receivers 21 are aligned in two directions (X-axis direction and Y-axis direction) orthogonal to the Z-axis direction. In FIG. 11, by aligning the plurality of receivers 21 in two directions orthogonal to the Z-axis direction, the overall shape of the reception surfaces 21a of the plurality of receivers 21 is a rectangle (or square) corresponding to the shape of the transmission surface 10a. It is more preferable that the plurality of receivers 21 be arranged as close to the subject 100 as possible in the Z-axis direction.

By arranging the receivers 21 having a small size of the reception surface 21a (the area of the reception surface 21a is not more than (2×λ)²) in a matrix, the total area of the reception surface 21a can be increased as in the above embodiment. As a result, even if the area of the subject 100 to be inspected is large, a defect 104 in the subject 100 can be inspected highly precisely and in a short time.

In the present disclosure, the plurality of receivers 21 are not limited to being arranged in a matrix form in which they are arranged vertically and horizontally without gaps, or arranged in an array form in which they are arranged in a linear direction without gaps, and may be arranged at least according to a predetermined pattern. The plurality of receivers 21 may be arranged in a pattern (for example, a lattice pattern or a checkered pattern) obtained for example by removing the receivers 21 from a matrix arranged state according to a predetermined rule. Moreover, the plurality of receivers 21 may be arranged in a line along a curved line (for example, a spiral). Further, the plurality of receivers 21 may be arranged in a pattern obtained by removing the receivers 21 according to a predetermined rule, from a state for example in which the plurality of receivers 21 are arranged in rows without gaps (for example, a pattern in which units composed of two receivers 21 are arranged in rows with a gap).

In the present disclosure, the transmitter 10 may transmit the ultrasonic beam W so as to spread in a fan-like or spherical shape as it moves away from the transmission surface 10a of the transmitter 10, for example.

In the present disclosure, as described above, the determination unit 40 that determines the presence or absence of defects in the inspection subject 100, is not limited to making determinations based on the relationship between the phase of the reference waveform and the phase of the waveform to be inspected. The determination unit 40 may perform determination, for example, based on the relationship between the shape of the reference waveform and the shape of the waveform to be inspected. As a specific example, the determination unit 40 may determine the presence or absence of defects based on a difference in shape between the reference waveform and the waveform to be inspected. That is, the determination unit 40 of the present disclosure may determine the presence or absence of a defect based on a relationship between the reference waveform and the waveform to be inspected.

The ultrasonic inspection device of the present disclosure may not include the storage unit 30 for storing reference waveforms, for example. In this case, in the ultrasonic inspection device, for example, ultrasonic waves are transmitted to the subject 100 to obtain a waveform to be inspected, and at the same time, ultrasonic waves are also transmitted to a separately prepared reference subject to generate a reference waveform, and these reference waveforms and the waveform to be inspected may be compared.

According to the present disclosure, even if the area of the subject to be inspected by the ultrasonic inspection device is large, defects in the subject can be inspected highly precisely and in a short time.

What is claimed is:

1. An ultrasonic inspection device comprising:
a transmitter configured to transmit an ultrasonic beam to a subject, and
a plurality of receivers that each have a reception surface configured to receive the ultrasonic beam having transmitted through the subject,
wherein an area of the reception surface of each of the plurality of receivers is equal to or less than (10×λ)², where λ is a wavelength of the ultrasonic beam.

2. The ultrasonic inspection device according to claim 1, wherein the plurality of receivers are arranged in a plurality of rows of receivers and a plurality of columns of receivers, or the plurality of receivers are arranged in a single row of receivers.

3. The ultrasonic inspection device according to claim 1, wherein the reception surface of each of the plurality of receivers has a square shape, and a length of one side of the square shape is equal to or less than (10×λ).

4. The ultrasonic inspection device according to claim 1, wherein the reception surface of each of the plurality of receivers has a rectangular shape, and a length of a short side of the rectangular shape is equal to or less than (10×λ).

5. The ultrasonic inspection device according to claim 1, wherein the reception surface of each of the plurality of receivers has a circular shape, and a diameter of the circular shape is equal to or less than (10×λ).

6. The ultrasonic inspection device according to claim 1, wherein the area of the reception surface of each of the plurality of receivers is equal to or less than (6×λ)².

7. The ultrasonic inspection device according to claim 1, wherein the area of the reception surface of each of the plurality of receivers is equal to or less than (4×λ)².

8. The ultrasonic inspection device according to claim 1, wherein the area of the reception surface of each of the plurality of receivers is equal to or less than (2×λ)².

9. The ultrasonic inspection device according to claim 1, wherein the plurality of receivers are arranged spaced apart from each other.

10. The ultrasonic inspection device according to claim 9, wherein the plurality of receivers are spaced apart from each other by a resin layer or an air layer, each of the resin layer and the air layer having acoustic characteristics that differ from acoustic characteristics of the plurality of receivers.

11. The ultrasonic inspection device according to claim 1, further comprising:
a memory configured to store instructions; and
a processor configured to execute the instructions to determine whether a defect is present in an inspection subject based on a relationship between a reference waveform and an inspection subject waveform, the inspection subject waveform being a waveform of the ultrasonic beam that has transmitted through the inspection subject and that has been received by at least one of the plurality of receivers.

12. The ultrasonic inspection device according to claim 11,
wherein the reference waveform is a waveform of the ultrasonic beam that has transmitted through a reference subject and that has been received by at least one of the plurality of receivers, and
wherein the processor is configured to execute the instructions to determine whether the defect is present in the inspection subject based on a correlation value between a phase of the reference subject waveform and a phase of the inspection subject waveform.

13. The ultrasonic inspection device according to claim 11,
wherein the reference waveform is a waveform of the ultrasonic beam that has transmitted through a reference subject and that has been received by at least one of the plurality of receivers, and
wherein the processor is configured to execute the instructions to determine whether the defect is present in the inspection subject depending on whether or not a phase of the inspection subject waveform differs from a phase of the reference waveform.

14. The ultrasonic inspection device according to claim 11, wherein the memory stores the reference waveform.

15. The ultrasonic inspection device according to claim 1,
wherein the ultrasonic beam is transmitted to the subject along a transmission direction, and the transmitter and/or the plurality of receivers are disposed in relation to the subject such that a distance, in a direction crossing the transmission direction, between (i) the transmitter and/or the plurality of receivers and (ii) an end of the subject is at least a length of the wavelength of the ultrasonic beam.

16. The ultrasonic inspection device according to claim 1, further comprising:
a field effect transistor (FET) substrate configured to output a received signal corresponding to the ultrasonic beam received by at least one of the plurality of receivers,
wherein the plurality of receivers are integrally provided on the FET substrate.
